(19) United States
(12) Patent Application Publication
(10) Pub. No.: US 2025/0363394 A1
(43) Pub. Date: Nov. 27, 2025

(54) METHOD FOR CONSTRUCTING FEATURE KNOWLEDGE BASE OF MAPPING BEHAVIOR BASED ON DEEP LEARNING

(71) Applicant: Huaneng Information Technology Co., Ltd., Qingdao (CN)

(72) Inventors: Yong Xiao, Qingdao (CN); Shuo Han, Qingdao (CN); Sheng Ye, Qingdao (CN); Hao Guo, Qingdao (CN); Wenwei Liu, Qingdao (CN); Cheng Fan, Qingdao (CN); Yubao Zhou, Qingdao (CN); Shouhui Xin, Qingdao (CN); Huanxiu Ding, Qingdao (CN); Wei Li, Qingdao (CN)

(73) Assignee: Huaneng Information Technology Co., Ltd., Qingdao (CN)

(21) Appl. No.: 19/286,203

(22) Filed: Jul. 30, 2025

(30) Foreign Application Priority Data
Jul. 4, 2025 (CN) 202510925937.8

(51) Int. Cl. G06N 5/022

(52) U.S. Cl. CPC G06N 5/022

(57) ABSTRACT

The disclosure belongs to the technical field of network security, and provides a method for constructing a feature knowledge base of mapping behavior based on deep learning, which includes: data acquisition and preprocessing: extracting five-tuple information and behavior features from network traffic. The disclosure automatically extracts the spatio-temporal features through the deep learning model, and enhances the sensitivity to abnormal behaviors by combining the attention mechanism, thus significantly improving the detection accuracy. The explanatory AI technology is used to automatically generate detection rules, the maintenance cost of manual rules is greatly reduced and the efficiency of rule generation is significantly improved. The feature knowledge base supports dynamic updating, may integrate third-party threat information in real time, and ensures the continuous defense ability against new attacks and variant detection means.

### CROSS-REFERENCE TO RELATED APPLICATIONS

This application claims priority of Chinese Patent Application No. 202510925937.8, filed on Jul. 4, 2025, the content of which is hereby incorporated by reference.

### TECHNICAL FIELD

The disclosure relates to the technical field of network security, and in particular to a method for constructing a feature knowledge base of mapping behavior based on deep learning.

### BACKGROUND

Network security refers to protecting the network system and data thereof from unauthorized access, destruction, modification or disclosure through technical and management measures, and ensuring the continuity, integrity and confidentiality of network services. With the development of information technology, network security has become an important cornerstone for safeguarding national security, social stability and economic development. With the continuous evolution and diversification of network attack means, distributed network detection behaviors (such as vulnerability scanning, port detection, asset mapping, etc.) are increasingly hidden and difficult to identify. Traditional network security defense methods mainly rely on static rule base and known attack features for matching detection, which is difficult to effectively deal with dynamic change detection technology and new attack means. The existing technology has the following outstanding problems in dealing with network detection behavior.

The current system mainly relies on manual analysis of network traffic features and manual writing of detection rules. This mode has slow response speed and high labor cost, and may not adapt to the rapid evolution of new detection behaviors in time. When attackers use variant technology or unknown detection means, the defense system based on static rules often appears serious omission. Moreover, the existing technology lacks the ability of deep correlation analysis of the mapping organization intention and behavior features, and may only make simple judgments based on the features of a single dimension (such as IP address and request frequency), so it is difficult to accurately distinguish normal business traffic, malicious detection behavior and legal security scanning, resulting in a high false alarm rate. Therefore, it needs to be improved.

### SUMMARY

The purpose of the disclosure is to provide a method for constructing a feature knowledge base of mapping behavior based on deep learning, so as to solve the problems raised in the above background technology.

In order to achieve the above objectives, the disclosure provides the following technical scheme: a method for constructing a feature knowledge base of mapping behavior based on deep learning is provided, and includes:
S1, data acquisition and preprocessing: extracting five-tuple information and behavior features from network traffic, and generating a time sequence feature matrix by sliding window algorithm, and outputting to S2;
marking anomaly traffic based on collaborative analysis of TLS fingerprint and HTTP header field, performing dynamic normalization processing on detection frequency and packet size, where a normalization formula is:

$${x}^{′} = \frac{x - {μ}_{h i s t}}{{σ}_{h i s t}} ;$$

where μₕᵢₛₜ is a historical traffic average value, and σₕᵢₛₜ is a standard deviation;
S2, receiving the time sequence feature matrix in S1, performing training by using a CNN-RNN hybrid model, where CNN branch extracts spatial features and RNN branch extracts temporal features, and outputting an anomaly detection model to S3 through attention mechanism;
S3, constructing a feature knowledge base: receiving the anomaly detection model in S2, explaining model decision by using a SHAP method, extracting and structuring key feature rules and storing as a knowledge base, and outputting to S4 and S5;
S4, mapping subject portrait and intention inference: receiving knowledge base data in S3, generating an organization portrait based on IP clustering, analyzing attack intention by combining a diamond model, and outputting intention labels to S5; and
S5, dynamic defense linkage: receiving the knowledge base in S3 and the intention labels in S4, and when malicious behavior is detected, calling layered forged data to perform progressive response according to rules and the intention labels in the knowledge base.

Preferably, in S1:
the five-tuple information includes an active IP, a destination IP, a source port, a destination port and a protocol type, the behavior features include detection frequency, packet size, TLS fingerprint, HTTP header field and detection time intervals, and extracting time sequence features by the sliding window algorithm;
where in the behavioral features, correlation analysis between the TLS fingerprint (JA3 hash) and the HTTP header field (such as User-Agent) includes:
when JA3 fingerprint matches a malicious tool library (such as Cobalt Strike) and User-Agent claims to be Mozilla/5.0, determining as disguised traffic;
when Referer field is missing in the HTTP header field and a TLS handshake duration is less than <100 ms, determining as an automatic scanning tool;
a training process of the CNN-RNN hybrid model in S2 includes: input data is the time sequence feature matrix generated by S1, and dimension is [N×T×F], where N is a number of samples, T is a number of time steps, and F is a number of features;
an output model is a classifier with attention weight, and is configured for rule extraction in S3.

Preferably, in S2:
the deep learning model adopts a two-channel input structure, discrete features are input by a first channel and are processed by a embedding layer, including IP address and port number, and are mapped into 64-dimensional vectors by the embedding layer, continuous features are input by a second channel and directly enter a convolutional neural network layer, including packet size and detection frequency, and are extracted by three-layer CNN (the convolution kernel sizes are 3, 5 and 7 respectively), finally, classification results are output through full connection layer fusion; where, in the two-channel input structure, an output dimension of a discrete feature embedding layer is 64, and feature graph size of the continuous features after three-layer CNN processing is 8×8, and a fusion layer adopts concatenate operation;
where concrete logic of S5 calling the knowledge base in S3 is: when a first-level rule in the knowledge base hits, immediately responding to an abnormal TCP flag bit; when S4 is labeled as APT organization, responding to fictitious subnet topology information.

Preferably, in S3:
constructing the feature knowledge base specifically includes dividing rules into three levels according to threat level:
first-level rule: detecting a number of port scanning per minute ≥100 and containing known vulnerabilities to use payload (such as /wp-admin path detection), with a weight coefficient of 0.9;
second-level rule: detecting probe requests (such as HTTP+SSH+RDP combination) of more than 5 protocols initiated by a single IP within 1 hour, with a weight coefficient of 0.6;
three-level rule: detecting slow scanning with scanning interval ≥10 minutes and duration ≥24 hours, with a weight coefficient of 0.3;
where, a weight coefficient is dynamically adjusted according to real-time threat information, and an adjustment formula is:

$${ω}_{i} = {ω}_{i} \times \frac{current attack frequency}{historical baseline frequency} ;$$

where t is an update period, and an initial weight (t=0) is set according to rule levels (0.9 for the first-level rule, 0.6 for the second-level rule and 0.3 for the third-level rule).

Preferably, in S4:
when mapping subject portrait is generated, performing ASN attribution analysis on IP address, marking organization attributes of including a commercial platform or an APT organization by combining with WHOIS information, and correlating the historical attack events through the knowledge map.

Preferably, the false information base in S5 includes:
the layered forged data includes: a network layer false TTL value, transport layer distortion TCP flag bit and application layer forged HTTP Server header, and is selectively used according to the protocol type.

Preferably, in S2:
in a model training stage, adopting countermeasure sample enhancement technology, and generating countermeasure detection traffic by FGSM algorithm, so as to improve robustness of the model.

Preferably, S3 further includes:
a rule validity verification module: configured for simulating and testing newly generated rules in a sandbox environment, and automatically triggering model to retrain when a false alarm rate exceeds 5%.

Preferably, when dynamic defense is linked in S5:
performing a progressive response strategy for continuous detection behaviors of a same attack source: responding to a part of false data for a first time and responding to completely wrong topology information for a third time.

Preferably, the method further includes a knowledge base visualization module: configured for displaying an organizational correlation relationship through a force-oriented diagram, marking a high-frequency attack path with a heat map, and supporting multi-dimensional screening query.

The disclosure has the following beneficial effects.

Firstly, the disclosure automatically extracts the spatio-temporal features through the deep learning model, and enhances the sensitivity to abnormal behaviors by combining the attention mechanism, thus significantly improving the detection accuracy. The explanatory AI technology is used to automatically generate detection rules, the maintenance cost of manual rules is greatly reduced and the efficiency of rule generation is significantly improved. The feature knowledge base supports dynamic updating, may integrate third-party threat information in real time, and ensures the continuous defense ability against new attacks and variant detection means. Through automatic feature extraction and rule generation, this scheme effectively reduces the false alarm rate and enables the security team to focus more on the disposal of high-priority threats.

Secondly, The disclosure constructs a mapping subject portrait including organizational attributes, behavioral characteristics and correlation relationships through multi-dimensional data analysis technology. Combined with advanced attack model analysis, the attacker's technical ability and attack intention may be inferred reversely. This deep correlation analysis may identify the common technical means and potential targets of the attacking organization, so that the defender may adjust the protection strategy in advance and realize the transition from passive defense to active prediction. Through in-depth understanding of the attacker's behavior, the security team may deploy more targeted defense measures and improve the overall security protection level.

Thirdly, the disclosure realizes active interference and misleading to malicious detection behavior through an innovative dynamic response mechanism. The system may generate multi-level false response information according to the features of different protocols, so that attackers may obtain wrong network asset information. Adopting the progressive response strategy may induce attackers to continuously expose scanning logic and technical features. This active defense method may not only protect the real asset information, but also significantly increase the attacker's investigation cost and time consumption. By regularly updating the false information base, the system may continuously keep the confusing effect on attackers and greatly improve the active defense ability of the network.

### BRIEF DESCRIPTION OF THE DRAWINGS

FIG. 1 is a flowchart according to embodiments of the disclosure.

### DETAILED DESCRIPTION OF THE EMBODIMENTS

In the following, the technical scheme in the embodiment of the disclosure will be clearly and completely described with reference to the attached drawings in the embodiment of the disclosure. Obviously, the described embodiment is only a part of the embodiment of the disclosure, but not all of embodiments. Based on the embodiments in the disclosure, all other embodiments obtained by ordinary skilled in the field without creative efforts belong to the scope of protection of the disclosure.

### Embodiment 1

A method for constructing a feature knowledge base of mapping behavior based on deep learning is provided, and includes:
S1, data acquisition and preprocessing: five-tuple information and behavior features are extracted from network traffic, and a time sequence feature matrix is generated by sliding window algorithm, and outputting to S2;
anomaly traffic is marked based on collaborative analysis of TLS fingerprint and HTTP header field, dynamic normalization processing is performed on detection frequency and packet size, where a normalization formula is:

$${x}^{′} = \frac{x - {μ}_{h i s t}}{{σ}_{h i s t}} ;$$

where μₕᵢₛₜ is a historical traffic average value, and σₕᵢₛₜ is a standard deviation;
S2, the time sequence feature matrix in S1 is received, training is performed by using a CNN-RNN hybrid model, where CNN branch extracts spatial features and RNN branch extracts temporal features, and an anomaly detection model is outputted to S3 through attention mechanism.
S3, constructing a feature knowledge base: the anomaly detection model in S2 is received, model decision is explained by using a SHAP method, key feature rules are extracted and structured, and stored as a knowledge base, and outputted to S4 and S5.
S4, mapping subject portrait and intention inference: knowledge base data in S3 is received, an organization portrait is generated based on IP clustering, attack intention is analyzed by combining a diamond model, and intention labels are outputted to S5; and
S5, dynamic defense linkage: the knowledge base in S3 and the intention labels in S4 are received, and when malicious behavior is detected, layered forged data is calls to perform progressive response according to rules and the intention labels in the knowledge base.

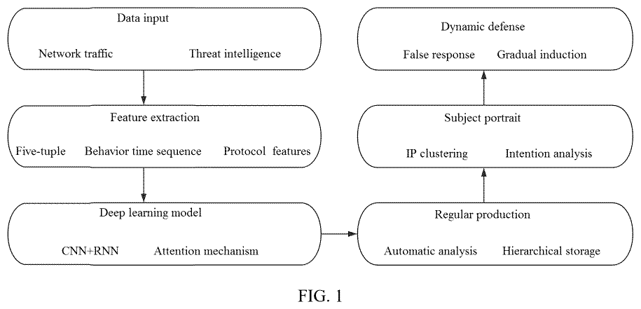

FIG. 1 is the overall flow chart of the disclosure, including the closed-loop flow of data acquisition→model training→knowledge base construction→dynamic defense, in which the dashed box indicates the interactive relationship between spatio-temporal feature extraction (step S2) and multi-dimensional analysis (step S4).

A complete technical chain from data acquisition, model training to dynamic defense is constructed, network traffic features are automatically extracted and detection rules are generated by the deep learning model, and active defense is realized by combining false response technology, which solves the problems that traditional schemes rely on manual rules and response is lagging behind, significantly improves the detection accuracy and real-time blocking ability of malicious scanning behavior, and reduces the operation and maintenance cost, and is suitable for automatic security protection of various network environments.

In the training of the deep learning model, CNN branch extracts the local spatio-temporal pattern of traffic data (such as the burstiness of port scanning) through multi-layer convolution kernel (such as 3×1 temporal convolution kernel), and RNN branch captures the long-period behavior features (such as the time interval law of slow speed scanning) through LSTM unit. Spatio-temporal feature fusion layer weights the feature importance of different time steps through attention mechanism, and finally outputs the anomaly probability.

Multi-dimensional data analysis includes:
basic dimension: the organizational attributes of IP (such as commercial company/APT organization) are marked by ASN and WHOIS information;
behavior dimension: cluster analysis of IP detection frequency, protocol distribution, and time law (such as weekday/night activity);
correlation dimension: based on the knowledge map, the correlation between IP and historical attack events is constructed (such as sharing C2 servers and the same vulnerability exploitation chain).

The dynamic response module adjusts the strategy according to the attack stage:
first detection: forged HTTP Server headers (such as ‘Apache/2.4.1’) is responded, but the true TTL value is kept;
third detection: malformed TCP flag bits (such as SYN+FIN) and false topology information (such as fictitious subnet 192.168.99.0/24) are responded.

### Embodiment 2

In S1:
the five-tuple information includes an active IP, a destination IP, a source port, a destination port and a protocol type, the behavior features include detection frequency, packet size, TLS fingerprint, HTTP header field and detection time intervals, and time sequence features are extracted by the sliding window algorithm;
where in the behavioral features, correlation analysis between the TLS fingerprint (JA3 hash) and the HTTP header field (such as User-Agent) includes:
when JA3 fingerprint matches a malicious tool library (such as Cobalt Strike) and User-Agent claims to be Mozilla/5.0, it is determined as disguised traffic;
when Referer field is missing in the HTTP header field and a TLS handshake duration is less than <100 ms, it is determined as an automatic scanning tool.
a training process of the CNN-RNN hybrid model in S2 includes: input data is the time sequence feature matrix generated by S1, and dimension is [N×T×F], where N is a number of samples, T is a number of time steps, and F is a number of features;
an output model is a classifier with attention weight, and is configured for rule extraction in S3.

On the basis of basic feature extraction, TLS fingerprint and HTTP header field analysis are added, and the sliding window algorithm is combined to capture time sequence features, which may effectively identify advanced evasion technologies such as encryption traffic camouflage and slow speed scanning, fill the blind spots of traditional detection methods for low-frequency and encryption detection behaviors, and greatly improve the detection coverage in complex attack scenarios.

### Embodiment 3

In S2:
the deep learning model adopts a two-channel input structure, discrete features are input by a first channel and are processed by a embedding layer, including IP address and port number, and are mapped into 64-dimensional vectors by the embedding layer, continuous features are input by a second channel and directly enter a convolutional neural network layer, including packet size and detection frequency, and are extracted by three-layer CNN (the convolution kernel sizes are 3, 5 and 7 respectively), finally, classification results are output through full connection layer fusion; where, in the two-channel input structure, an output dimension of a discrete feature embedding layer is 64, and feature graph size of the continuous features after three-layer CNN processing is 8×8, and a fusion layer adopts concatenate operation;
where concrete logic of S5 calling the knowledge base in S3 is: when a first-level rule in the knowledge base hits, an abnormal TCP flag bit is immediately responded; when S4 is labeled as APT organization, fictitious subnet topology information is responded.

Two-channel input design is adopted to deal with discrete network features and continuous behavior features respectively, and the network topology relationship is automatically learned through the embedded layer, which avoids the limitations of artificial feature engineering, significantly reduces the false alarm rate compared with the single model architecture, and improves the generalization ability of the model to new attack modes.

The CNN layer adopts three layers of convolution kernels (sizes 3, 5 and 7 respectively), with a step size of 1 and an activation function of ReLU. The number of hidden units in LSTM layer is 128, and the attention mechanism adopts Scaled Dot-Product Attention.

### Embodiment 4

In S3:
constructing the feature knowledge base specifically includes dividing rules into three levels according to threat level: first-level rule corresponds to high-frequency port scanning plus specific payload features; second-level rule corresponds to single IP multi-protocol detection features; three-level rule corresponds to slow speed scanning features, and dynamic weight coefficients are set;
first-level rule: a number of port scanning per minute ≥100 is detected and known vulnerabilities are contained to use payload (such as /wp-admin path detection), with a weight coefficient of 0.9;
second-level rule: probe requests (such as HTTP+SSH+RDP combination) of more than 5 protocols initiated by a single IP within 1 hour are detected, with a weight coefficient of 0.6;
three-level rule: slow scanning with scanning interval ≥10 minutes and duration ≥24 hours is detected, with a weight coefficient of 0.3;
where, a weight coefficient is dynamically adjusted according to real-time threat information, and an adjustment formula is:

$${ω}_{i} = {ω}_{i} \times \frac{current attack frequency}{historical baseline frequency} ;$$

where t is an update period, and an initial weight (t=0) is set according to rule levels (0.9 for the first-level rule, 0.6 for the second-level rule and 0.3 for the third-level rule).

A three-level threat classification mechanism and a dynamic weight adjustment strategy are proposed, which may automatically optimize the priority of rules according to real-time threat information, realize accurate resource allocation and differentiated response disposal, solve the problems of rigid traditional rule base and high maintenance cost, and make the defense system have the ability of continuous evolution.

### Embodiment 5

In S4:
when mapping subject portrait is generated, ASN attribution analysis is performed on IP address, organization attributes including a commercial platform or an APT organization are marked by combining with WHOIS information, and the historical attack events are correlated through the knowledge map.

By integrating ASN attribution, WHOIS registration information and knowledge mapping technology, a three-dimensional portrait including organizational attributes, behavior patterns and attack history is constructed, which supports attack source tracing and intention inference, breaks through the traditional flat defense mode of IP blacklist and provides intelligence support for targeted defense strategy formulation.

### Embodiment 6

The false information base in S5 includes:
the layered forged data includes: a network layer false TTL value, transport layer distortion TCP flag bit and application layer forged HTTP Server header, and is selectively used according to the protocol type.

The layered deception mechanism of network layer, transport layer and application layer is designed, which may dynamically generate forged data according to the features of the protocol, and induce attackers to expose more information through a progressive response strategy. Compared with simple traffic blocking, the initiative and confusion of defense are significantly improved, and the investigation cost of attackers is prolonged.

### Embodiment 7

In S2:
in a model training stage, countermeasure sample enhancement technology is adopted, and countermeasure detection traffic is generated by FGSM algorithm, so as to improve robustness of the model.

The antagonistic sample generation technology is introduced, and the model training is strengthened by simulating the attacker's escape means, so that the detection system may resist common antagonistic attacks (such as traffic disturbance and protocol confusion), which solves the problem that the traditional machine learning model is easily bypassed and improves the actual combat reliability of the system.

### Embodiment 8

S3 further includes:
a rule validity verification module: configured for simulating and testing newly generated rules in a sandbox environment, and automatically triggering model to retrain when a false alarm rate exceeds 5%.

A rule quality evaluation system is constructed through sandbox testing and false alarm rate monitoring, which automatically triggers model iterative optimization, ensures the accuracy and timeliness of knowledge base rules, forms a complete closed loop from rule generation to verification optimization, and greatly reduces the impact of invalid rules on business.

### Embodiment 9

When dynamic defense is linked in S5:
a progressive response strategy is performed for continuous detection behaviors of a same attack source: a part of false data is responded for a first time and completely wrong topology information is responded for a third time.

Based on the dynamic response logic of the attack phase, providing a part of false information at the initial stage induces the attacker to keep moving, and the completely wrong network topology is fed back at the later stage, which effectively interferes with the information gathering process of the attacker, and may destroy the integrity of the attack chain more than a single blocking strategy.

Tests show that the progressive response increases the average stay time of attackers by 300%, where, 60% of the attack sources stops scanning because of having got the wrong topology.

### Embodiment 10

The method further includes a knowledge base visualization module: configured for displaying an organizational correlation relationship through a force-oriented diagram, marking a high-frequency attack path with a heat map, and supporting multi-dimensional screening query.

### Embodiment 11

The clustering results of IP segment 192.168.1.0/24 show that:
80% of the traffic comes from ASN 12345 (marked as cloud service provider), and behavior features are low-frequency HTTP detection (normal business);
20% of the traffic comes from ASN 67890 (without WHOIS information), and behavior features are multi-port scanning +TLS fingerprint camouflage (malicious behavior), and match the attack map of the known APT organization ‘X’.

The visual presentation of threat relationship is realized by force-oriented diagram and heat map, which supports multi-dimensional interactive analysis, helps security personnel to quickly grasp the attack situation and related clues, improves the efficiency of security operation and the quality of decision-making, and solves the problem of information overload of traditional log analysis tools.

It should be noted that in this disclosure, relational terms such as first and second are only used to distinguish one entity or operation from another entity or operation, and may not necessarily require or imply that there is any such actual relationship or order between these entities or operations. Moreover, the terms “include”, “including” or any other variation thereof are intended to cover non-exclusive inclusion, so that a process, method, article or device including a series of elements includes not only those elements, but also other elements not explicitly listed or elements inherent to such process, method, article or device.

Although embodiments of the disclosure have been shown and described, it will be understood by those skilled in the art that various changes, modifications, substitutions and variations may be made to these embodiments without departing from the principles and spirit of the disclosure, the scope of which is defined by the appended claims and their equivalents.

What is claimed is:

1. A method for constructing a feature knowledge base of mapping behavior based on deep learning, comprising:
S1, data acquisition and preprocessing: extracting five-tuple information and behavior features from network traffic, and generating a time sequence feature matrix by sliding window algorithm, and outputting to S2;
marking anomaly traffic based on collaborative analysis of TLS fingerprint and HTTP header field, performing dynamic normalization processing on detection frequency and packet size, wherein a normalization formula is:
$${x}^{′} = \frac{x - {μ}_{h i s t}}{{σ}_{h i s t}} ;$$
wherein μₕᵢₛₜ is a historical traffic average value, and σₕᵢₛₜ is a standard deviation;
S2, receiving the time sequence feature matrix in S1, performing training by using a CNN-RNN hybrid model, wherein CNN branch extracts spatial features and RNN branch extracts temporal features, and outputting an anomaly detection model to S3 through attention mechanism;
S3, constructing a feature knowledge base: receiving the anomaly detection model in S2, explaining model decision by using a SHAP method, extracting and structuring key feature rules and storing as a knowledge base, and outputting to S4 and S5;
S4, mapping subject portrait and intention inference: receiving knowledge base data in S3, generating an organization portrait based on IP clustering, analyzing attack intention by combining a diamond model, and outputting intention labels to S5; and
S5, dynamic defense linkage: receiving the knowledge base in S3 and the intention labels in S4, and when malicious behavior is detected, calling layered forged data to perform progressive response according to rules and the intention labels in the knowledge base.

2. The method for constructing a feature knowledge base of mapping behavior based on deep learning according to claim 1, wherein in S1:
the five-tuple information comprises an active IP, a destination IP, a source port, a destination port and a protocol type, the behavior features comprise detection frequency, packet size, TLS fingerprint, HTTP header field and detection time intervals, and extracting time sequence features by the sliding window algorithm;
wherein in the behavioral features, correlation analysis between the TLS fingerprint and the HTTP header field comprises:
when JA3 fingerprint matches a malicious tool library and User-Agent claims to be Mozilla/5.0, determining as disguised traffic;
when Referer field is missing in the HTTP header field and a TLS handshake duration is less than <100 ms, determining as an automatic scanning tool;
a training process of the CNN-RNN hybrid model in S2 comprises: input data is the time sequence feature matrix generated by S1, and dimension is [N×T×F], wherein N is a number of samples, T is a number of time steps, and F is a number of features;
an output model is a classifier with attention weight, and is configured for rule extraction in S3.

3. The method for constructing a feature knowledge base of mapping behavior based on deep learning according to claim 1, wherein in S2:
the deep learning model adopts a two-channel input structure, discrete features are input by a first channel and are processed by a embedding layer, comprising IP address and port number, and are mapped into 64-dimensional vectors by the embedding layer, continuous features are input by a second channel and directly enter a convolutional neural network layer, comprising packet size and detection frequency, and are extracted by three-layer CNN, finally, classification results are output through full connection layer fusion;
wherein, in the two-channel input structure, an output dimension of a discrete feature embedding layer is 64, and feature graph size of the continuous features after three-layer CNN processing is 8×8, and a fusion layer adopts concatenate operation;
wherein concrete logic of S5 calling the knowledge base in S3 is: when a first-level rule in the knowledge base hits, immediately responding to an abnormal TCP flag bit; when S4 is labeled as APT organization, responding to fictitious subnet topology information.

4. The method for constructing a feature knowledge base of mapping behavior based on deep learning according to claim 1, wherein in S3:
constructing the feature knowledge base specifically comprises dividing rules into three levels according to threat level:
first-level rule: detecting a number of port scanning per minute ≥100 and containing known vulnerabilities to use payload, with a weight coefficient of 0.9;
second-level rule: detecting probe requests of more than 5 protocols initiated by a single IP within 1 hour, with a weight coefficient of 0.6;
three-level rule: detecting slow scanning with scanning interval ≥10 minutes and duration ≥24 hours, with a weight coefficient of 0.3;
wherein, a weight coefficient is dynamically adjusted according to real-time threat information, and an adjustment formula is:
$${ω}_{i} = {ω}_{i} \times \frac{current attack frequency}{historical baseline frequency} ;$$
wherein t is an update period, and an initial weight (t=0) is set according to rule levels (0.9 for the first-level rule, 0.6 for the second-level rule and 0.3 for the third-level rule).

5. The method for constructing a feature knowledge base of mapping behavior based on deep learning according to claim 1, wherein in S4:
when mapping subject portrait is generated, performing ASN attribution analysis on IP address, marking organization attributes of comprising a commercial platform or an APT organization by combining with WHOIS information, and correlating the historical attack events through the knowledge map.

6. The method for constructing a feature knowledge base of mapping behavior based on deep learning according to claim 1, wherein the false information base in S5 comprises:
the layered forged data comprises: a network layer false TTL value, transport layer distortion TCP flag bit and application layer forged HTTP Server header, and is selectively used according to the protocol type.

7. The method for constructing a feature knowledge base of mapping behavior based on deep learning according to claim 1, wherein in S2:
in a model training stage, adopting countermeasure sample enhancement technology, and generating countermeasure detection traffic by FGSM algorithm, so as to improve robustness of the model.

8. The method for constructing a feature knowledge base of mapping behavior based on deep learning according to claim 1, wherein S3 further comprises:
a rule validity verification module: configured for simulating and testing newly generated rules in a sandbox environment, and automatically triggering model to retrain when a false alarm rate exceeds 5%.

9. The method for constructing a feature knowledge base of mapping behavior based on deep learning according to claim 1, wherein when dynamic defense is linked in S5:
performing a progressive response strategy for continuous detection behaviors of a same attack source: responding to a part of false data for a first time and responding to completely wrong topology information for a third time.

10. The method for constructing a feature knowledge base of mapping behavior based on deep learning according to claim 1, further comprises a knowledge base visualization module: configured for displaying an organizational correlation relationship through a force-oriented diagram, marking a high-frequency attack path with a heat map, and supporting multi-dimensional screening query.
